(19) United States
(12) Patent Application Publication
(10) Pub. No.: US 2005/0100695 A1
(43) Pub. Date: May 12, 2005

(54) Low surface energy blends useful in the manufacture of ovenable containers

(76) Inventors: Victor Paul Holbert, Loveland, OH (US); David Verd Reed, Blanchester, OH (US); Christopher S. Cleveland, Cincinnati, OH (US); James Irvin Marchman, Cincinnati, OH (US)

Correspondence Address: INTERNATIONAL PAPER COMPANY, 6285 TRI-RIDGE BOULEVARD, LOVELAND, OH, 45140, US

(21) Appl. No.: 10/706,437

(22) Filed: Nov. 12, 2003

(51) Int. Cl. B27N 1/00; B32B 27/08; B32B 27/30; B32B 27/34; B32B 27/10

(52) U.S. Cl. 428/34.2; 428/342; 428/475.5; 428/513; 428/500; 428/522

(57) ABSTRACT

A laminate useful in the manufacture of ovenable grease resistant food containers, which have the added advantage of good release from the food products, particularly those containing high levels of starch and sugar. The laminate of the present invention includes a substrate, preferably of a paperboard, a layer of grease resistant material, such as polyamide, polyester, polyvinyl chloride, polytetrafluoroethylene, or polyvinyl alcohol, etc., or nylon, a tie layer of low density polyethylene or linear low density polyethylene modified with maleic anhydride, and a food contact release layer comprising a blend of polypropylene and polymethylpentene. In the preferred embodiment, the grease resistant layer, the tie layer and the food contact release layer are coextruded onto a paperboard substrate.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention relates to laminates useful in the manufacture of containers for products, e.g., food, which are ovenable while the product is in the container.

2. Background Of Invention

In the prior art, it has been proposed that ovenable food containers be manufactured from a laminate comprising a paperboard substrate, a grease resistant layer applied to the substrate, and a polymethylpentene (PMP) outer food contact layer, which is bonded to the grease resistant layer by a tie layer. Such laminates are both difficult to produce and costly, in part due to the relative high cost of PMP. One major difficulty in producing this prior art laminate is the difficulty in obtaining good adherence of the PMP layer to the underlying grease resistant layer. Resolution of this bonding limitation has been attempted by using a modified graft copolymer of methylpentene as a distinct tie layer interposed between a layer of PMP and the grease resistant layer. This copolymer is relatively expensive and is no longer commercially available.

Another attempt to resolve the problem of adhesion of PMP to a grease resistant layer involves use of a different “tackifier” resin, namely, maleic anhydride modified ethylene polymers or ethylene-propylene copolymers. This composition is intended to function as a potential enhancer to the “sticking” of the PMP homopolyer or copolymer to the propylene monomers. Cost and production problems are associated with this proposed solution.

### BRIEF SUMMARY OF THE INVENTION

In accordance with one aspect of the present invention, there is provided a laminate useful in the manufacture of ovenable grease resistant food containers, which have the added advantage of good release from the food products, particularly those containing high levels of starch and sugar. The laminate of the present invention includes a substrate, preferably of a paperboard, a layer of grease resistant material, such as polyamide, polyester, polyvinyl chloride, polytetrafluoroethylene, or polyvinyl alcohol, etc., a tie layer of low density polyethylene or linear low density polyethylene modified with maleic anhydride, and a food contact layer comprising a blend of polypropylene and polymethylpentene. In the preferred embodiment, the grease resistant layer, the tie layer and the food contact layer are coextruded onto a paperboard substrate.

The food contact release layer of the present invention is both less costly versus a 100% PMP layer at the time of its purchase and, importantly, has been found to exhibit higher softening and melting points than non-blends of polymeric materials which have heretofore been employed as the product release layer in ovenable containers. This latter property of the present laminate provides a dramatic increase in the range of the applicable end-use temperatures. The laminate of the present invention is most useful for manufacturing trays, bowls or plates.

### BRIEF DESCRIPTION OF THE SEVERAL VIEWS OF THE DRAWINGS

FIG. 1 is a schematic representation of one embodiment of a laminate of the present invention.

FIG. 2 is a schematic representation of the laminate of FIG. 1 and including a grease resistant layer and a tie layer; and

FIG. 3 is a schematic representation of the laminate of FIG. 2 and including a second tie layer.

### DETAILED DESCRIPTION OF THE INVENTION

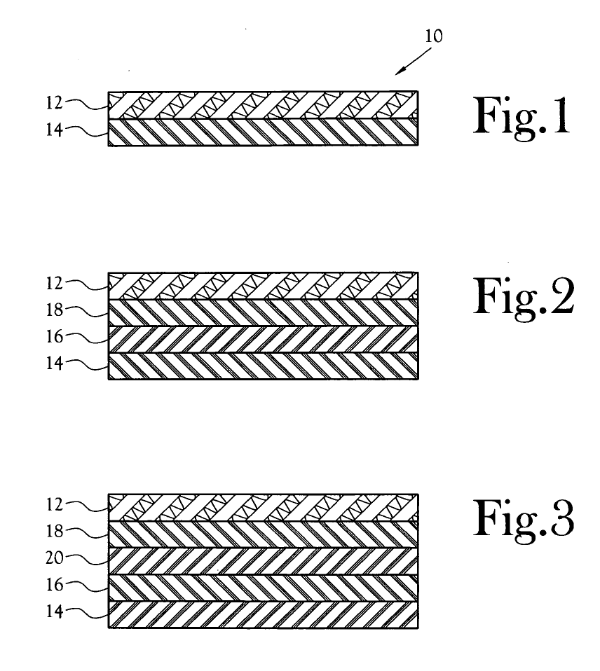

With reference to FIG. 1, one embodiment of a laminate 10 embodying various of the features of the present invention includes a paper board substrate 12 and a food contact release layer 14.

In FIG. 2, there is depicted a further embodiment of the laminate depicted in FIG. 1 and including a tie layer 16 and a grease resistant layer 18 interposed between the food contact release layer 14 and the paperboard 12. In similar manner, FIG. 3 depicts the laminate of FIG. 2 and including a further tie layer 20 interposed between the first tie layer and the grease resistant layer 18.

In one embodiment, the paperboard substrate is bleached board having a basis weight of between about 18 and about 320 lbs/3000 ft². The choice of basis weight for the paperboard substrate is primarily a function of the strength and/or rigidity needed or desired in the end product container. Unbleached kraft having a basis weight in the same range can also be used for applications where a white board is not needed or desired. For specific applications, such as non-ovenable containers, substrates of other materials such as polymeric webs or sheets may be employed.

The grease resistant layer of the present invention may include polyamides such as nylon 6, nylon 6,6, etc., polyesters such as polyethylene terephthalate (PET); halogenated polymers such as polytetrafluoroethylene; polyvinyl alcohol; or other like polymeric materials. Nylon 6 is preferred for many applications by reason of its relatively high impermeability to grease and oils, which may emanate for a food product contained with a container formed from a laminate embodying the present invention. It has been found that a grease resistant layer thickness of 3-10 lbs/3000 ft² will provide an adequate barrier to grease penetration and adhesion to the paperboard.

A suitable tie layer for a laminate of the present invention may include low density polyethylene (LDPE) or linear low density polyethylene (LLDPE), either being modified by maleic anhydride as is well known in the art. Other suitable tie layers may include polyolefins modified with comonomers such as vinyl acetate, acrylic acid or methacrylic acid, depending upon whether the nylon is replaced by another material such as foil and improved inter-layer bonding is required. One suitable tie layer material is a maleic anhydride modified LDPE sold by Equistar Chemical under the tradename Plexar. The coat weight of the tie layer may range between about 1 and 25 lbs/3000 ft². The coat weight of this tie layer is adjusted depending upon whether or not adequate inter-layer adhesion has been achieved. As well, an increase in the tie material coat weight supplies both increased mass and heat that will improve the adhesion of the co-extruded structure to the paperboard.

In accordance with one aspect of the present invention, the product contact layer of the present laminate comprises a blend of polypropylene (PP) and polymethylpentene (PMP). This blend is readily prepared by dry-mixing powdered or pelletized PP and PMP. No special compounding steps nor other processing aids are required.

As noted, even though PMP alone is useful as a product contact layer in an ovenable container, it is relatively expensive and the market for laminates useful in the manufacture of ovenable containers is highly competitive. The present inventors have found that blending PMP with PP (which is materially less expensive than PMP) can provide a blend, which offers several benefits.

First, the addition of the PP to the blend reduces the overall cost of the product contact layer. The average market price of PP is $0.38-0.40/lb. The approximate price of PMP is $2.50/lb. Therefore, a blend comprised of 50% PP, by weight, would cost up to 43% less than a 100% PMP layer. Other polyolefins such as low-density polyethylene (LDPE), linear low-density polyethylene (LLDPE), and ethylene-propylene copolymers could be used in such blends.

Also, the blend exhibits enhanced bonding of the blend to the tie layer. It appears that this enhanced bonding is a function of the attraction of the PP in the PP/PMP blend to the polyolefin in the tie layer. For the purpose of extrusion coating, the polypropylene is actually a random copolymer of propylene with a small amount of ethylene. The presence of the propylene, and to a greater degree, the ethylene helps to improve the level of adhesion between the tie material and the PMP containing layer.

These benefits also include an extrudable blend, which exhibits a low surface tension. A release coating should have a lower surface tension than the material to applied to it. A structure with excellent release properties is basically preventing adhesion of the second material. The surface tensions of several materials are listed in Table 1.

TABLE I
Surface Tensions of Several Materials at 20° C.

| Material | Surface Tension (dynes/cm) |
|---|---|
| Water | 73 |
| Starch | 39 |
| Polytetrafluoroethylene (Teflon) | 18 |
| Polymethyl pentene (PMP) | 24 |
| Polypropylene (PP) | 29 |
| Polyethylene terephthalate | 43 |
| (PET) | |

PTFE is known to have the lowest surface tension of any solid material at 17 dynes/cm. PMP and PP have been measured at 24 and 29 dynes/cm, respectively. In contrast, water has a surface tension of 76 dynes/cm. That is why water tends to bead on the surface of polyolefins like PP and will not wet and penetrate the surface. Given that the surface tension of starch is 39 dynes/cm, it should not adhere to PMP or PP. However, it will probably “stick” to PET as it has a lower surface tension than PET. This is important in the present invention since starch and materials with “starch-like” chemistries (i.e. sugars) are ingredients in cookies, breads, rolls, etc. PET is also often used as a dual-ovenable coating for paperboard packaging. As illustrated here, a PMP/PP blend will offer a more favorable “non-stick” surface for baking.

It has been found that the PP may comprise the majority of the composition of the blend, but preferably ranges between about 25% and 75%, by weight, of the blend, and most preferably about 50%, by weight, of the blend. Adequate release properties can be achieved for blend compositions with greater than 65% PP, by weight. However, for high temperature applications (>300° F.), higher weight percentages of PMP are necessary as the melting temperature (Tₘ) of PMP is approximately 460° F. versus approximately 280-300° F. for PP. Four blend compositions were tested for release of biscuits and cookies following baking at 350-400° F. for 15-30 minutes. The qualitative assessment of each of the blends is listed in Table II.

TABLE II
Release Quality for Each Blend Composition

| Blend | Quality of | |
|---|---|---|
| Composition | Release | Comments/Observations |
| 75% PMP:25% PP | Excellent | Products removed with |
| | | no observed defects in polymer |
| | | film |
| | | film |
| 50% PMP:50% PP | Excellent | Products removed with |
| | | no observed defects in polymer |
| | | film |
| 25% PMP:75% PP | Fair | Some tackiness between |
| | | polymer & oven mitt |
| 0% PMP:100% PP | Poor | Great deal of tackiness |
| | | & material delamination |

The low surface energy laminate of the present invention can also be used in applications where scuff resistance is desired. For instance, the laminate could be used as a protective layer for glass and glass-like materials, where scratching may be an issue.

In order to create a structure that involves nylon and the PMP/PP blend, it is necessary to use a tie material. The tie material promotes adhesion between the polar nylon and the non-polar PMP/PP blend. Without the tie layer, the nylon and PMP/PP layers tend to peel apart.

It is also believed that the PMP/PP blend of the present invention may be extrusion coated directly to the paperboard without other layers.

1. A laminate useful in the manufacture of packages for containers for food products comprising
a paperboard substrate,
a food contact release layer comprising a blend of polymethylpentene and polypropylene bonded to one side of said substrate,
the laminate being ovenable.

2. The laminate of claim 1 wherein said food contact release layer comprises a blend of between about 25% and about 75%, by weight, of the blend.

3. The laminate of claim 1 wherein said food contact release layer exhibits a surface tension of between about 24 and about 29 dynes/cm.

4. The laminate of claim 1 wherein said food contact release layer is of a thickness of between about 3 and about 10 lbs/3000 ft².

5. The laminate of claim 1 wherein said paperboard is of a basis weight of between about 18 and 320 lbs/3000 ft².

6. The laminate of claim 1 and including a tie layer interposed between said paperboard substrate and said food contact release layer.

7. The laminate of claim 6 wherein said tie layer comprises low density polyethylene or linear low density polyethylene, modified by maleic anhydride, vinyl acetate, acrylic acid or methacrylic acid.

8. The laminate of claim 6 wherein the coat weight of said tie layer is between about 1 and about 25 lbs/3000 ft².

9. The laminate of claim 1 wherein said food contact release layer exhibits a surface tension of less than about 40% of the surface tension of water at 20° C.

10. The laminate of claim 1 wherein said food contact release layer exhibits a surface tension of less than about 75% of the surface tension of starch whereby food products may be baked when disposed in a container formed from the laminate of claim 1.

11. The laminate of claim 1 and including a grease resistant layer and a tie layer, said tie layer being disposed between said food contact release layer and grease resistant layer.

12. The laminate of claim 1 wherein said food contact release layer is extruded onto said paperboard substrate.

13. An ovenable, grease resistant laminate useful in the manufacture of packages or containers for food products comprising,
a substrate,
a grease resistant layer,
a tie layer,
a food contact layer,
said tie layer being disposed between said grease resistant layer and said food contact layer,
said grease resistant layer, said tie layer and said good contact layer being coextruded onto said substrate.

14. The laminate of claim 13 wherein said grease resistant layer comprises nylon-6 or nylon 6,6.

15. The laminate of claim 14 wherein said substrate comprises a paperboard having a basis weight of between about 18 and about 320 lbs/3000 ft².

16. The laminate of claim 15 wherein said food product layer release layer comprises a blend of between about 25% and about 75%, by weight, of the blend, of polymethyl pentene with the remainder being polypropylene.

17. The laminate of claim 16 wherein said tie layer comprises low density polyethylene or linear low density polyethylene, modified with maleic anhydride, vinyl acetate, acrylic acid or methacrylic acid.

18. The laminate of claim 13 wherein said laminate exhibits a surface tension of less than about 75% of the surface tension of starch at 20° C.

19. The laminate of claim 13 wherein said laminate is formed into trays, bowls or plates.
